(19) United States
(12) Patent Application Publication
(10) Pub. No.: US 2011/0089863 A1
(43) Pub. Date: Apr. 21, 2011

(54) DISPLAY-USE LIGHTING DEVICE AND DISPLAY APPARATUS

(75) Inventor: Takanori Makino, Tokyo (JP)

(73) Assignee: TAKA INTERNATIONAL CO. LTD., Tokyo (JP)

(21) Appl. No.: 12/997,755

(22) PCT Filed: Jun. 16, 2008
(86) PCT No.: PCT/JP2008/060989

§ 371 Date: Dec. 13, 2010

(51) Int. Cl. H05B 37/02

(52) U.S. Cl. 315/294

(57) ABSTRACT

A display-use lighting device and display apparatus are provided. The display-use lighting device is provided with a light device which is provided with visible light emitting devices and ultraviolet light emitting devices and a control unit. The control unit performs control to make the visible light emitting devices emit light, gradually increase a light emitting intensity, then gradually decrease this light emitting intensity and extinguish the light, then make the ultraviolet light emitting devices emit light, gradually increase a light emitting intensity, then gradually decrease this light emitting intensity and extinguish the light, and alternately periodically repeats the light emitting operations of the visible light emitting devices and the light emitting operations of the ultraviolet light emitting devices. The visible light emission and the ultraviolet light emission are alternately periodically repeated.

### TECHNICAL FIELD

The present invention relates to a display-use lighting device and a display apparatus, more particularly relates to a display-use lighting device and a display apparatus suitable for lighting an artistic display of an exhibit, a showpiece, a presentation, a painting, or the like and able to change the lighting conditions so as to change the nature of the display.

### BACKGROUND ART

As conventional lighting devices, the lighting devices described in Patent Document 1 and Patent Document 2 may be mentioned. The lighting device disclosed in Patent Document 1 is provided with, as light bulbs, ultraviolet lamps and incandescent bulbs, and is configured to repeatedly control only the operations of the incandescent bulbs to turn them on, adjust the luminance, and turn them off over time. On the other hand, the ultraviolet lamps are kept in the on state. Further, the lighting device disclosed in Patent Document 2 is similarly provided with, as light bulbs, ultraviolet lamps and incandescent bulbs and is configured to periodically turn the ultraviolet lamps on and off while controlling the operations of the incandescent bulbs to turn them on, adjust the luminance, and turn them off during the intervals when the ultraviolet lamps are off. Several patterns of change are prepared for the patterns of change of operations of the incandescent bulbs. One is selected from among these.

Further, in Non Patent Document 1, one surface of a lighting device is provided with a large number of light emitting devices (specifically, LEDs). The light emitting devices include, for example, a group of light emitting diodes emitting blue (B), a group of light emitting diodes emitting red (R), and a group of light emitting diodes emitting ultraviolet (UV) light. This discloses to use a lighting device provided with light emitting diodes to light up a picture drawn on wall paper and to switch the operations of the groups of light emitting diodes to successively light up the picture by a plurality of light beams and thereby change the color and design of the wallpaper.

### Patent Document 1: Japanese Patent No. 2829503

### Patent Document 2: Japanese Patent No. 2880476

Non Patent Document 1: Kabusikki Kaisya So-Ken, website “http://www.trickwall.com/trickwall.html”, trick walls, special LED light fixtures, May 30, 2008.

### DISCLOSURE OF INVENTION

### Technical Problem

In the lighting devices disclosed in the above-mentioned Patent Documents 1 and 2, the control for periodically changing the luminance was performed only for the incandescent bulbs. It was not possible to provide a picture etc. able to be displayed or expressed with a sufficiently high marketability from an artistic viewpoint. This is because the means for producing ultraviolet light was use of ultraviolet lamps utilizing fluorescent tubes. There was the problem that technical limitations made it impossible to sufficiently perfect this technology. Further, the lighting devices disclosed in Patent Documents 1 and 2 were attached to frames of pictures by arms along members forming single sides of the frames. The lighting devices were designed to light up the pictures using incandescent bulbs and ultraviolet lamps from the front sides of the frames. These conventional lighting devices were therefore only configured to light up framed pictures from the front sides. This was a major limitation for a lighting device for display use.

In the lighting device for wallpaper use disclosed in Non Patent Document 1, it is possible to use the LED light emitting devices to emit several colors (R, G, and B) of light so as to change the color of the wallpaper or emit ultraviolet light to reveal a hidden picture and thereby change the design of the wallpaper. However, the color of the picture was not the color of the picture itself. It was given by the colors of the light emitted by the light emitting devices. Furthermore, this lighting technique brings out an image on white wallpaper by ultraviolet light. That is, this brings out an image from nothing. The changes in color seen due to the lighting are only changes in appearance due to application of colored light to a white wall. The image itself is not changed.

An object of the present invention, in view of the above issues, is to provide a display-use lighting device and display apparatus which are configured utilizing white light and other visible light emitting devices and ultraviolet light emitting devices, which can freely control each light emitting intensity of the visible light and the light emitting intensity of the ultraviolet light, which, furthermore, can combine printing techniques enabling high precision and rich color expression so as to display or express a picture etc. with a sufficiently high marketability from an artistic viewpoint, and which, furthermore, can increase the degree of freedom of direction of emission of the visible light and ultraviolet light.

### Solution to Problem

The display-use lighting device and display apparatus according to the present invention, to achieve the above object, are configured as follows.

The display-use lighting device according to the present invention is provided with a light device which is provided with at least one visible light emitting device and at least one ultraviolet light emitting device and a control means for alternately controlling a light emitting operation of the visible light emitting device and a light emitting operation of the ultraviolet light emitting device in the light device. The control means performs control to make the visible light emitting device emit light, gradually increase a light emitting intensity, then gradually decrease this light emitting intensity and extinguish the light, then make the ultraviolet light emitting device emit light, gradually increase a light emitting intensity, then gradually decrease this light emitting intensity and extinguish the light, and alternately periodically repeats this light emitting operation of the visible light emitting device and this light emitting operation of the ultraviolet light emitting device. As a result, visible light which the visible light emitting device emits and ultraviolet light which the ultraviolet light emitting device emits are alternately irradiated on a display object.

In the display-use lighting device, the display object includes an image part which is sensitive to the visible light and an image part which is sensitive to the ultraviolet light.

In the display-use lighting device, a pattern of change of the light emitting operation of the visible light emitting device and a pattern of change of the light emitting operation of the ultraviolet light emitting device, which are controlled by the control means, are the same.

In the display-use lighting device, a pattern of change of the light emitting operation of the visible light emitting device and a pattern of change of the light emitting operation of the ultraviolet light emitting device, which are controlled by the control means, are made different.

In the display-use lighting device, the light device is provided with a single board, and a plurality of the visible light emitting devices and a plurality of the ultraviolet light emitting devices are arranged on one surface of this board.

In the display-use lighting device, electrical circuit elements forming the control means are provided on the other surface of the board.

In the display-use lighting device, the display-use lighting device is provided with a supporting box member which mounts the display object, and the light device is arranged along a side-forming member of the supporting box member.

In the display-use lighting device, the light device is set inside of the supporting box member, and the display object is alternately irradiated with the visible light from the visible light emitting devices and the ultraviolet light from the ultraviolet light emitting devices from the front surface side of the display object arranged in the supporting box member.

In the display-use lighting device, the light device is set inside of the supporting box member, and the display object is alternately irradiated with the visible light from the visible light emitting devices and the ultraviolet light from the ultraviolet light emitting devices from the back surface side of the display object arranged in the supporting box member.

In the display-use lighting device, the side-forming member of the supporting box member which is provided with the light device can freely move to a predetermined position in front of the supporting box member, and the image display member mounted to the supporting box member is irradiated by the light device with the visible light or the ultraviolet light in the state where the side-forming member has moved to the front.

In the display-use lighting device, the control means is provided with a period changing means for changing a period of a periodic light emitting operation of the visible light emitting device and a periodic light emitting operation of the ultraviolet light emitting device.

The display apparatus according to the present invention is provided with an image display member for display use, a light device which is provided with a visible light emitting device and an ultraviolet light emitting device, and a control means for alternately controlling a light emitting operation of the visible light emitting device and a light emitting operation of the ultraviolet light emitting device in the light device. The control means performs control to make the visible light emitting device emit light, gradually increase a light emitting intensity, then gradually decrease this light emitting intensity and extinguish the light, then make the ultraviolet light emitting device emit light, gradually increase a light emitting intensity, then gradually decrease this light emitting intensity and extinguish the light, and alternately periodically repeats the light emitting operation of the visible light emitting device and the light emitting operation of the ultraviolet light emitting device. The visible light which the visible light emitting device emits and ultraviolet light which the ultraviolet light emitting device emits are alternately irradiated on the image display member.

In the display apparatus, the image display member includes an image part which is sensitive to the visible light and an image part which is sensitive to the ultraviolet light.

In the display apparatus, a pattern of change of the light emitting operation of the visible light emitting device and a pattern of change of the light emitting operation of the ultraviolet light emitting device, which are controlled by the control means, are the same.

In the display apparatus, a pattern of change of the light emitting operation of the visible light emitting device and a pattern of change of the light emitting operation of the ultraviolet light emitting device, which are controlled by the control means, are made different.

In the display apparatus, the light device is provided with a single board, and a plurality of the visible light emitting devices and a plurality of the ultraviolet light emitting devices are arranged on one surface of this board.

In the display apparatus, the display apparatus is provided with a supporting box member which mounts the image display member, and the light device is arranged along a side-forming member of the supporting box member.

In the display apparatus, the light device is set inside of the supporting box member, and the image display member is alternately irradiated with the visible light from the visible light emitting devices and the ultraviolet light from the ultraviolet light emitting devices from the front surface side of the image display member arranged in the supporting box member.

In the display apparatus, the light device is set inside of the supporting box member, and the image display member is alternately irradiated with the visible light from the visible light emitting devices and the ultraviolet light from the ultraviolet light emitting devices from the back surface side of the image display member arranged in the supporting box member.

In the display apparatus, the side-forming member of the supporting box member which is provided with the light device can freely move to a predetermined position in front of the supporting box member, and the image display member mounted to the supporting box member is irradiated by the light device with the visible light or the ultraviolet light in the state where the side-forming member has moved to the front.

### ADVANTAGEOUS EFFECTS OF INVENTION

According to the display-use lighting device of the present invention, LEDs or other light emitting devices are used for the visible light emitting means and ultraviolet emitting means, the light emitting operations of the visible light emitting devices and the light emitting operations of the ultraviolet light emitting devices are similarly made to periodically alternately change, and, furthermore, the light emitting operations can be individually set, so the light emitting intensity of the visible light and the light emitting intensity of the ultraviolet light can be freely controlled, it is possible to realize a display-use lighting device suitable for lighting an artistic display of an exhibit, a showpiece, a presentation, a painting, or the like, and it is possible to change the lighting conditions so as to change the contents or nature of the display.

According to the display apparatus of the present invention, the lighting device configured in this way is provided and that lighting device is utilized to light up a display object having an image region sensitive to visible light and an image region sensitive to ultraviolet light, so it is possible to realize a display apparatus suitable for lighting an artistic display of an exhibit, a showpiece, a presentation, a painting, or the like, it is possible to change the lighting conditions so as to change the contents or nature of the display more precisely and beautifully, it is possible to display or express a picture etc. with a sufficiently high marketability from an artistic viewpoint, and, furthermore, it is possible to increase the degree of freedom of direction of emission of the visible light and ultraviolet light.

### BEST MODE FOR CARRYING OUT THE INVENTION

Below, preferred embodiments (examples) for carrying out the present invention will be explained based on the attached drawings.

Referring to FIG. 1 to FIG. 7, a representative embodiment of the display apparatus according to the present invention will be explained. FIG. 1 is a front view of the display apparatus, FIG. 2 is a cross-sectional view along the line A-A of FIG. 1, and FIG. 3 is an external perspective view.

As shown in FIG. 1 to FIG. 3, the display apparatus 10 is configured to be incorporated into the inside of a box member 11, for example, which forms a device housing. The box member 11 is formed from a front surface part 11A, a back surface part 11B, and side surface parts 11C. Note that instead of the box member, this may also be a frame member formed by mainly side surface parts. The front surface part 11A, for example, is formed with a rectangular opening part 11A-1. The back surface part 11B is a plate-shaped member. The side surface parts 11C are comprised of two left and right and two top and bottom parts, that is, a total of four side parts. The front surface part 11A and the back surface part 11B are arranged in parallel. Further, the front surface part 11A and the back surface part 11B are connected by the side surface parts 11C comprised of the four side parts.

Inside the box member 11, as shown in FIG. 2, preferably a display object 12 is arranged in front of the inside surface of the back surface part 11B. The box member 11 is therefore a housing supporting the display object. The display object 12, for example, is formed by a plate-shaped member. Furthermore, on the surface of the plate-shaped member display content relating to an artistic design of goods or products is drawn, which is used for an exhibit, a showpiece, a presentation, a painting, a photograph, an advertisement, or the like. The display object 12 is arranged at the inside of the box member 11 at a position at the front side from the back surface part 11B by being fastened by for example screws, elastic pressing members, or any other fastening means 13. Further, the display object 12 may be provided inside the box member 11 detachably by for example magnet means or press-fitting means. According to such a detachable configuration, the display object 12 set in the box member 11 can be suitably and quickly changed in accordance with the object and therefore the display content provided by the display apparatus 10 can be freely changed.

FIG. 4 is a front view of the display object 12. The display content of the display object 12 may be any content. It is possible to draw a design in accordance with the purpose. In the example shown in FIG. 4, the design 12A and the design 12B are drawn as abstract pictures etc. The design 12A is shown by the solid lines in FIG. 4, for example, is comprised of drawings of mountains and trees. The design 13B is shown by the broken lines in FIG. 4, for example, is comprised of drawings of the moon and stars which can be seen at night. The designs 12A and 12B of the display object 12 presented by the display apparatus 10 are irradiated by visible light and/or ultraviolet by the later explained lighting device 14. That is, at respectively set predetermined times (time intervals), the display object 12 is irradiated by only visible light, only ultraviolet light, or both visible light and ultraviolet light. In this case, the visible light is in general for example light of a red (R), green (G), blue (B), or other color, but in the present embodiment, preferably white light produced by combining RGB is utilized. Therefore, as the designs 12A and 12B drawn on the display object 12, there are a design 12A able to be viewed under white visible light (below, referred to as “visible light”) and a design 12B able to be viewed only under ultraviolet light. The design 12A is drawn by usual artist's paint etc. The design 12B is drawn utilizing a substance sensitive to ultraviolet light. The design 12B appears when it is irradiated by ultraviolet light, while does not appear when it is irradiated by only visible light.

For convenience in explanation, the designs 12A and 12B drawn at the display object 12 shown in FIG. 4 are drawn divided into different locations on the surface. However, the two designs can be drawn overlapping at the same location depending on the contents of the designs. In this case, in the present invention, the image according to the design drawn at the display object 12 is given a “dual layer structure” based on the printing technology applied. That is, the layer of the image sensitive to natural light (visible light) is printed by CMKY printing ink, while the layer of the image sensitive to ultraviolet light is printed overlapped on that CMYK image using UV-emitting special RGB ink. By using an image expressed by printing technology utilizing such a dual layer structure for expression of the design of the display object 12, it is possible to combine a CMYK image and an image prepared by UV-emitting special RGB ink without offset and thereby possible to obtain an expressive effect changing the image provided by the display object 12 more finely. Furthermore, the original image is characterized in the point that it is not a single layer image, but is an image which is finely changed in design or color by formation of multiple layers, something not seen in the past, at the stage of formation in the basic processing.

In the above, as shown in FIG. 2, the lighting device (light device) 14 has a rectangular shape and is arranged inside the box member 11 for example along the right side part in the vertical direction. The lighting device 14 in this embodiment is comprised as an internal emission type lighting means. That is, the lighting device 14 is provided at the inside of the box member 11 and emits visible light and/or ultraviolet light from the front side of the display object 12. The visible light and/or ultraviolet light are emitted based on the change of luminance explained later (changes in light emitting intensity). Furthermore, in this case, the plate-shaped member forming the display object 12 is a non-transparent member. When the front surface of the display object 12 is irradiated by visible light and/or ultraviolet light from the light device 14, the display content of the display object 12 is displayed due to the reflection action. The content of display of the display object 12 can be seen from the front through the opening part 11A-1 of the front surface part 11A of the box member 11.

The position of arrangement of the display object 12 inside the box member 11 can be made the front surface part 11A side. In this case, the lighting device 14 is arranged at the back side of the display object 12, so the visible light and/or ultraviolet light emitted from the lighting device 14 are irradiated at the back surface of the display object 12. For this reason, the plate-shaped member forming the display object 12 is fabricated by a transparent member. The method of emission of the visible light etc. in this case is the internal emission system forming a backlight system.

Next, referring to FIG. 5 to FIG. 9, the configuration and light emitting operation of the lighting device 14 will be explained in detail. FIG. 5 is a view of the front side of the lighting device 14, FIG. 6 is a view of the back side of the lighting device 14, FIG. 7 is a view of the configuration of an electrical circuit for control use, FIG. 8 is a flowchart showing the setting of the content of control and execution of the light operations by the visible light emitting devices and the ultraviolet light emitting devices of the lighting device, and FIG. 9 is a timing chart showing waveforms according to patterns of change of luminance of the visible light and ultraviolet light emitted from the lighting device.

As shown in FIG. 5 and FIG. 6, the lighting device 14 is preferably comprised of an assembly of a plurality of light emitting devices 22A and 22B utilizing the front surface and back surface of the same single board 21, a control unit (control chip) 23, and a power supply (battery) 24 which feeds power to the light emitting devices and control unit. The lighting device 14 is basically assembled on a single board to form a single unit and is comprised as a single light device.

The plurality of light emitting devices (22A and 22B) are arranged in a suitable array over the entire surface at the front surface of the board 21. The light emitting devices are for example LEDs. The plurality of light emitting devices are divided into two groups of light emitting devices. The first group of light emitting devices is a group of light emitting devices 22A which emit visible light at the time of being driven. The second group of light emitting devices is a group of light emitting devices 22A which emit ultraviolet (UV) light at the time of being driven. The plurality of light emitting devices 22A and the plurality of light emitting devices 22B are arranged in a state suitably mixed at the front surface of the board 21. Note that the positions of arrangement of the light emitting devices can be set at two regions dividing them into the group of light emitting devices 22A and the group of light emitting devices 22B. Further, just one each of the light emitting devices 22A and 22B can also be arranged.

As shown in FIG. 7, the plurality of light emitting devices 22A and the plurality of light emitting devices 22B are controlled in states of feed of current from the power supply 24 based on the control signals S1 and S2 given from the control unit 23. Reference numerals 25 and 26 show current adjusting units. The current adjusting unit 25 uses the control signal S1 given from the control unit 23 to adjust the amount of current fed to the plurality of light emitting devices 22A. The current adjusting unit 26 uses the control signal S2 given from the control unit 23 to adjust the amount of current fed to the plurality of light emitting devices 22B. The plurality of light emitting devices 22A emitting the visible light are all simultaneously controlled in light emitting operation. Further, the plurality of light emitting devices 22b emitting the ultraviolet light are all simultaneously controlled in light emitting operation.

Next, in accordance with FIG. 8 and FIG. 9, the settings of control contents and execution of the light emitting operations of the light emitting devices 22A and 22B based on the control unit 23 in the lighting device 14 will be explained.

In FIG. 8, at the initial step S11, it is judged if the power of the display apparatus 10 is ON. When the power is ON, the routine proceeds to the next step S12. Step S12 is a step of “automatic judgment”. It is judged whether the mode is the “setting” mode or the “lighting operation” mode. The criteria for judgment is, for example, if a predetermined external terminal is connected to a PC etc. If the external terminal is connected, it is judged that the mode is the “setting” mode, the setting screen is shifted to, and the content shown by block 40 is set on the setting screen. When the external terminal is not connected, it is judged if the mode is the “lighting operation” mode and the routine proceeds to the next step S13 of the “menu”.

The content of the block 40 will be explained next. The first step S41 is the step of the setting menu. At this setting menu S41, whether to set the frequency or whether to designate the preset time is set. When setting the frequency, the routine proceeds to step S42. When designating the preset time, the routine proceeds to step S71.

At step S42 of the frequency menu, the frequency relating to the visible light or the frequency relating to the ultraviolet (UV) light is selected. When the frequency according to the visible light is selected, the routine proceeds to step S51. When the frequency relating to the ultraviolet (UV) light is selected, the routine proceeds to step S61.

At the side of the above step S51 relating to the visible light and the succeeding steps S52 and S53, the “FULL menu (menu for designation relating to light emission time at maximum output)”, “DIMM menu (menu for designation relating to time of change from maximum output to cut of output)”, and “Int. menu (menu for designation relating to time of cut of output)” are successively set with designations of numbers of seconds nA, nB, and nC. After this, the flow of the processing returns to the setting menu S41.

Further, in the same way, even at the processing route of the above step S61 relating to the ultraviolet (UV) light and the succeeding steps S62 and S63, “FULL menu (menu for designation relating to light emission time at maximum output)”, “DIMM menu (menu for designation relating to time of change from maximum output to cut of output)”, and “Int. menu (menu for designation relating to time of cut of output)” are successively set with designations of numbers of seconds nD, nE, and nF. After this, the flow of the processing returns to the setting menu S41

Next, when designating the preset time at step S41 of the setting menu, the routine proceeds to step S71 where a multiple of the preset time is designated. For the multiples of the preset time, three variables X, Y, and Z are set. For these variables, values of multiples of the preset time are set. When the multiple of the preset time finishes being designated, the processing of the block 40 is ended by an instruction to turn off the power (step S72).

Next, the content of the processing for control of the lighting operation from step S13 will be explained. Step S13 is a judgment step relating to the menu. Here, whether to continue operation or end it is judged. When ending it is instructed, the power is turned off (step S14) to end the operation. When continuing the operation is instructed, the routine proceeds to step S15 where the operating pattern is selected. As the operating pattern, as one example, three operating patterns 1 to 3 based on presets 1 to 3 are prepared. Waveform patterns of the changes (change of luminance) in the light emitting intensity of visible light and the changes (change of luminance) in the light emitting intensity of ultraviolet light (UV) based on each of the operating patterns 1 to 3 are shown in FIG. 9.

According to the waveform patterns of FIG. 9, the meanings of the designations of the numbers of seconds nA, nB and nC, the designations of the numbers of second nD, nE and nF, and the three variables X, Y and Z relating to the multiples of the preset time are clarified.

At step S15, one of the three operating patterns 1 to 3 is selected. After this, the routine proceeds to the next step S16.

At step S16, based on the selected one of the operating patterns, the light emitting operations of the plurality of visible light emitting devices 22A and the plurality of ultraviolet light emitting devices 22B of the lighting device 14 are controlled.

According to the waveform patterns of FIG. 9, the light emitting operations of the visible light emitting devices 22A and the light emitting operations of the ultraviolet light emitting devices 22B of the lighting device 14 are alternately controlled. Furthermore, the patterns of change of the light emitting operations of the visible light emitting devices 22A and the light emitting operations of the ultraviolet light emitting devices 22B are preferably the same patterns of change. That is, the visible light emitting devices 22A are made to emit light, gradually increase the light emitting intensity, then gradually decrease the light emitting intensity and extinguish the light, then the ultraviolet light emitting devices 22B are made to emit light, gradually the light emitting intensity, then gradually decrease the light emitting intensity and extinguish the light. The light emitting operations of the visible light emitting devices 22A and the ultraviolet light emitting devices 22B are alternately periodically repeated. In the above way, visible light which is emitted by the visible light emitting devices 22A and ultraviolet light which is emitted by the ultraviolet light emitting devices 22B are alternately irradiated on the display object 12.

According to the waveform patterns of FIG. 9, the display object 12 can sometimes be irradiated with only visible light, sometimes be irradiated with only ultraviolet (UV) light, and sometimes be irradiated by both visible light and ultraviolet (UV) light. When gradually raising the ultraviolet (UV) light in light emitting intensity from the off state, the visible light is in the completely off state. At the stage where the ultraviolet light emitting devices 22B start emitting light, the visible light emitting devices 22B are in the completely off state. On the other hand, when gradually raising the visible light in light emitting intensity from the off state, control is performed so this overlaps the time when the light emitting intensity of the ultraviolet (UV) light gradually falls.

In the above, the patterns of change of the light emitting operations of the visible light emitting devices 22A and the patterns of change of the light emitting operations of the ultraviolet light emitting devices 22B which are controlled by the control unit 23 can be made different.

The light emitting operations of the visible light emitting devices 22A and the ultraviolet light emitting devices 22B in the lighting device 14 are continued so long as it is not judged YES at the judgment step S17 for judging whether to end the operations. If judged YES at the judgment step S17, the power is turned off (step S18) and the lighting operation of the light device 14 of the display apparatus 10 is ended.

As clear from the description of the above embodiments, it is possible to control the light emitting operations of the visible light emitting devices 22A and the light emitting operations of the ultraviolet light emitting devices 22B by the same patterns of change. Furthermore, by suitably setting the designations of numbers of seconds nA, nB, and nC, the designations of numbers of seconds nD, nE, and nF, and three variables X, Y, and Z relating to the multiples of the preset time, it is possible to individually set the patterns of change of light emitting operations of the visible light emitting devices 22A and ultraviolet light emitting devices 22B. The lighting device 14 for the display apparatus 10 of the present application invention can make the light emitting operations of the visible light emitting devices 22A and the ultraviolet light emitting devices 22B change by the same patterns of change while imparting uniqueness and thereby give a good image to the viewer and provide an extremely revolutionary display effect.

Further, the object of control of the light emitting operations of the visible light emitting devices 22A and the ultraviolet light emitting devices 22B of the lighting device 14 according to the present invention is to change the image drawn on the display object 12. The patterns of appearance of the images (designs 12A and 12B) sensitive to the lights are controlled by the light emitting patterns of the white visible light by the visible light emitting devices 22A and the ultraviolet light by the ultraviolet light emitting devices 22B. By smoothly changing the image drawn by printing of a dual layer structure on the display object 12 by lighting under the lighting device 14, a good impression is given to the viewer and a soothing effect is exhibited.

Next, referring to FIG. 10 and FIG. 11, a display apparatus according to another embodiment of the present invention will be explained. FIG. 10 is a front perspective view of that display apparatus, while FIG. 11 is a side view of the same.

In the display apparatus 110 according to this embodiment, the display object 112 is set at the front surface part 111A side of the box member 111. The display object 112 is the same as the display object 12 explained above. Further, a lighting device 113 is mounted in a light device box 114 provided in the vicinity of for example the top side part of the box member 111. The configuration and functions of the lighting device 113 are substantially the same as the lighting device 14 explained in the above-mentioned embodiment. The light device box 114 provided in the vicinity of the top side part of the box member 111 is attached by arm parts 115 to the left and right side parts 111B of the box member 111. The light device box 114 is arranged with respect to the box member 111 so that when the lighting operation is not being performed, it is arranged along the top side part of the box member 111 as shown by the solid lines in FIG. 10 or FIG. 11 and so that when the lighting operation is being performed, it is arranged at a position suitable for lighting the display object 112 by tilting the arm parts 116 forward as shown by the imaginary lines of FIG. 11. The arm parts 115 are configured to be movable utilizing a well known structure and mechanism. Under the lighting by the lighting device 113 in the state shown in FIG. 11, visible light and/or ultraviolet light is irradiated on the display object 112 from the front side whereby a reflection type lighting means is formed. According to the above embodiments, by storing the integral light device 113 in the light device box 114 and tilting the arm parts 115 forward at the time of use for light, it is possible to fasten the light device box 114 at the best position for the viewer.

In the above, it was described that the light device box 114 was arranged along the top side part of the box member 111, but this may also be deemed as a member forming the top side part of the box member 111. Furthermore, the member forming the top side part of the box member 111 may also be formed as a light device box. Further, the location of arrangement of the light device box is not limited to the top side part.

The configurations, shapes, sizes, and arrangements explained in the above embodiment are only shown schematically to an extent enabling the present invention to be understood and worked. Further, the numerical values and compositions of the configurations (materials) etc. are only illustrations. Therefore, the present invention is not limited to the explained embodiment. It may be changed in various ways insofar as not exceeding the scopes of the technical ideas shown in the claims.

### INDUSTRIAL APPLICABILITY

The display-use lighting device etc. according to the present invention may be utilized for lighting up an artistic display of an exhibit, a showpiece, a presentation, a painting, etc.

### BRIEF DESCRIPTION OF DRAWINGS

FIG. 1 is a front view showing a representative embodiment of a display apparatus according to the present invention.

FIG. 2 is a cross-sectional view along the line A-A in FIG. 1.

FIG. 3 is an external perspective view of a display apparatus according to the present invention.

FIG. 4 is a front view showing, extracted, only the display object provided at the inside of the display apparatus.

FIG. 5 is a front view showing, extracted, only the part of the light device provided at the inside of the display apparatus.

FIG. 6 is a back view of a lighting device.

FIG. 7 is a circuit diagram of an electrical circuit for control of a lighting device.

FIG. 8 is a flowchart showing the control of the lighting operations by visible light emitting devices and ultraviolet light emitting devices of the lighting device.

FIG. 9 is a timing chart showing the waveforms according to patterns of change of luminance of visible light and ultraviolet light emitted from the lighting device.

FIG. 10 is a front perspective view of another embodiment of the display apparatus according to the present invention.

FIG. 11 is a side view of the case where a change in status occurs in the display apparatus according to another embodiment of the present invention.

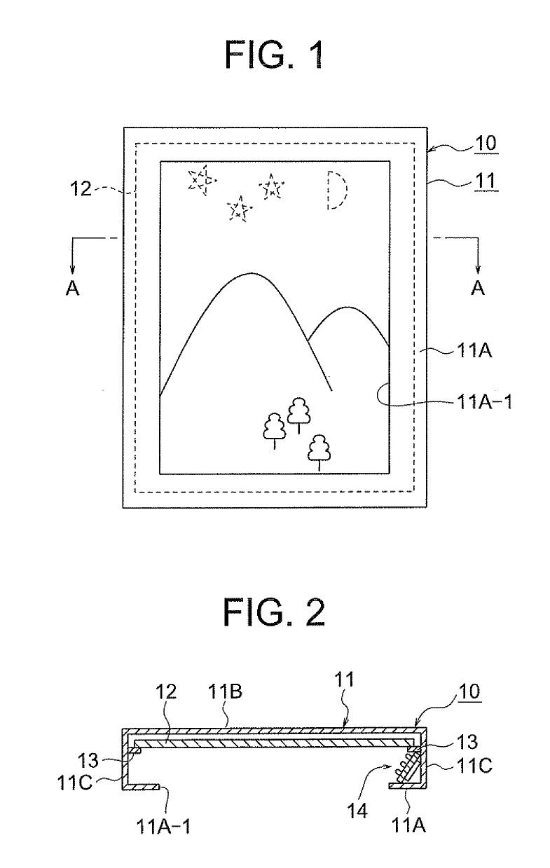

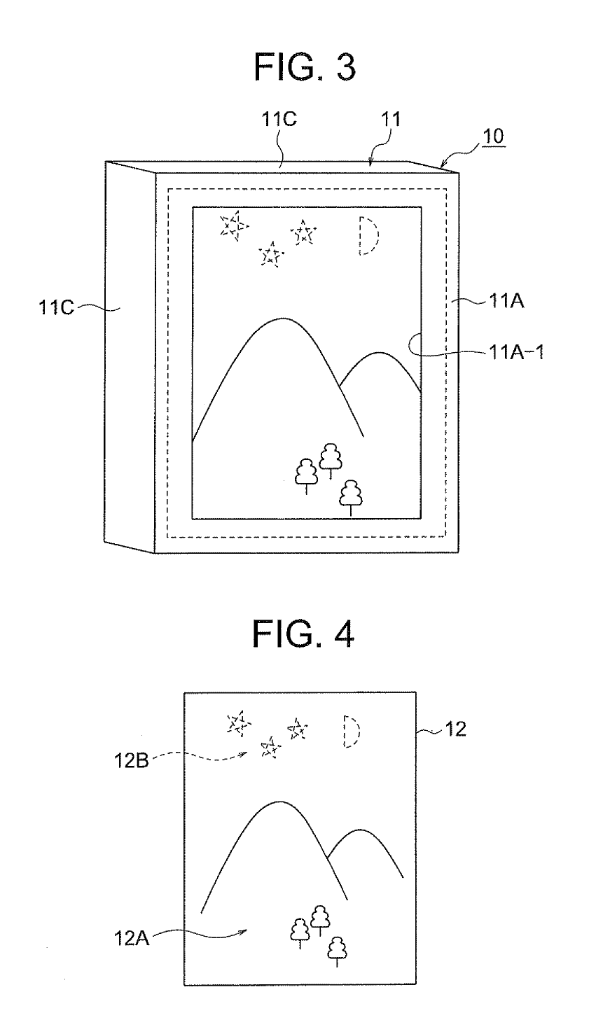

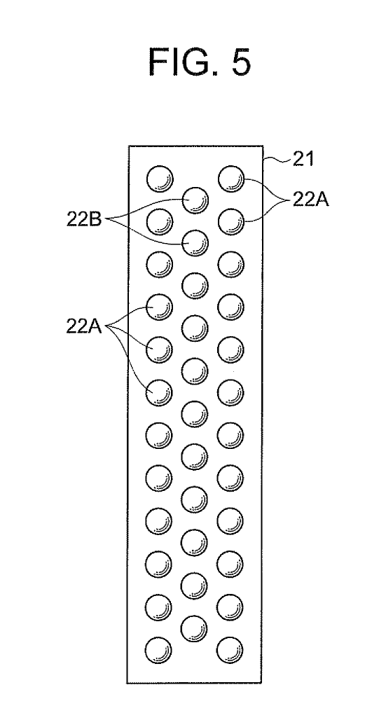

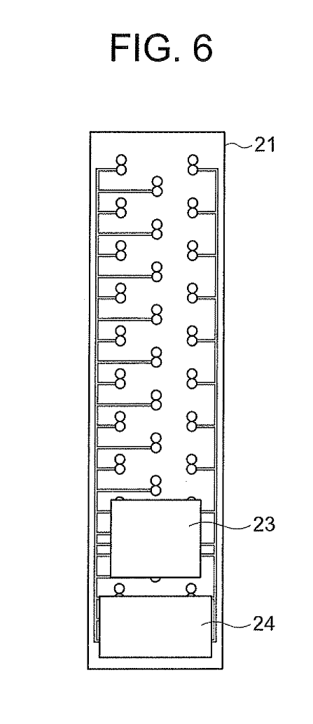

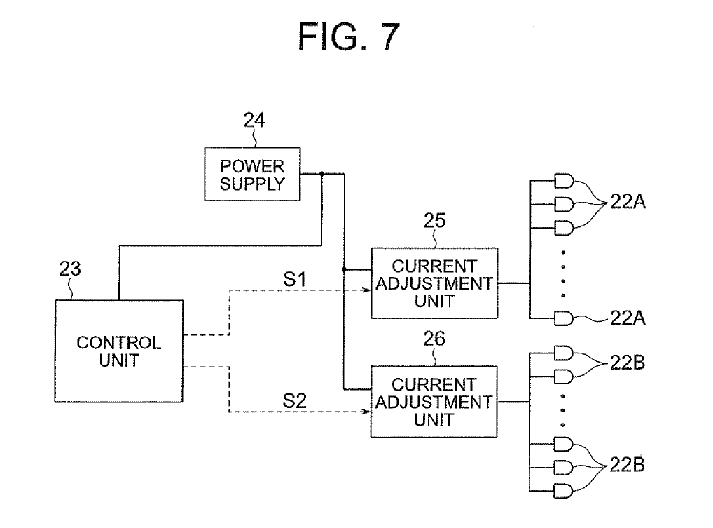

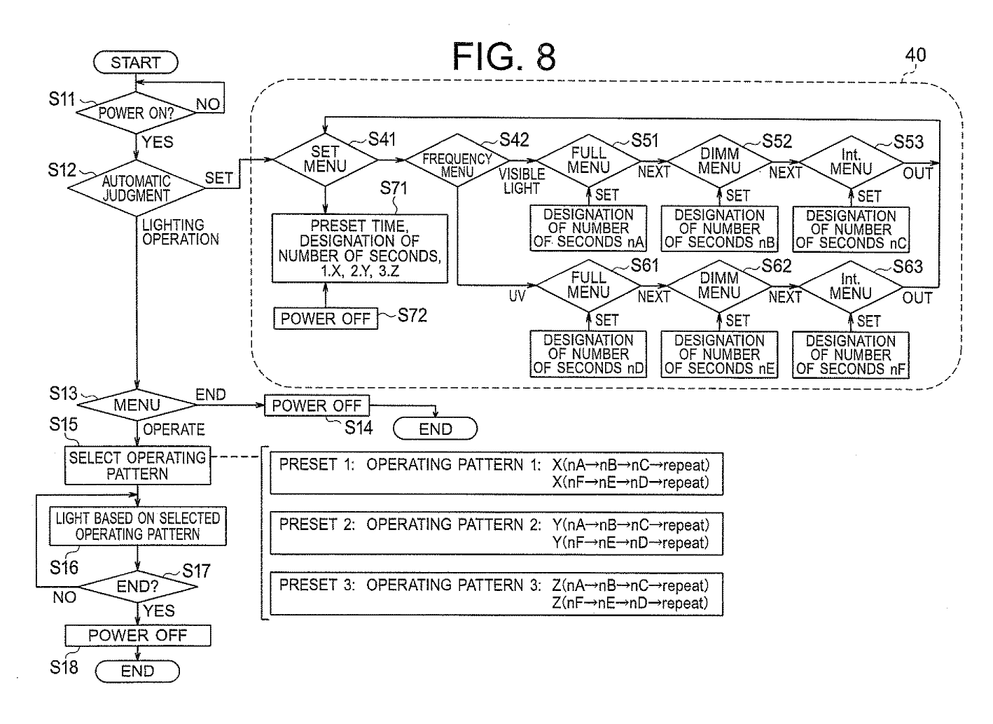

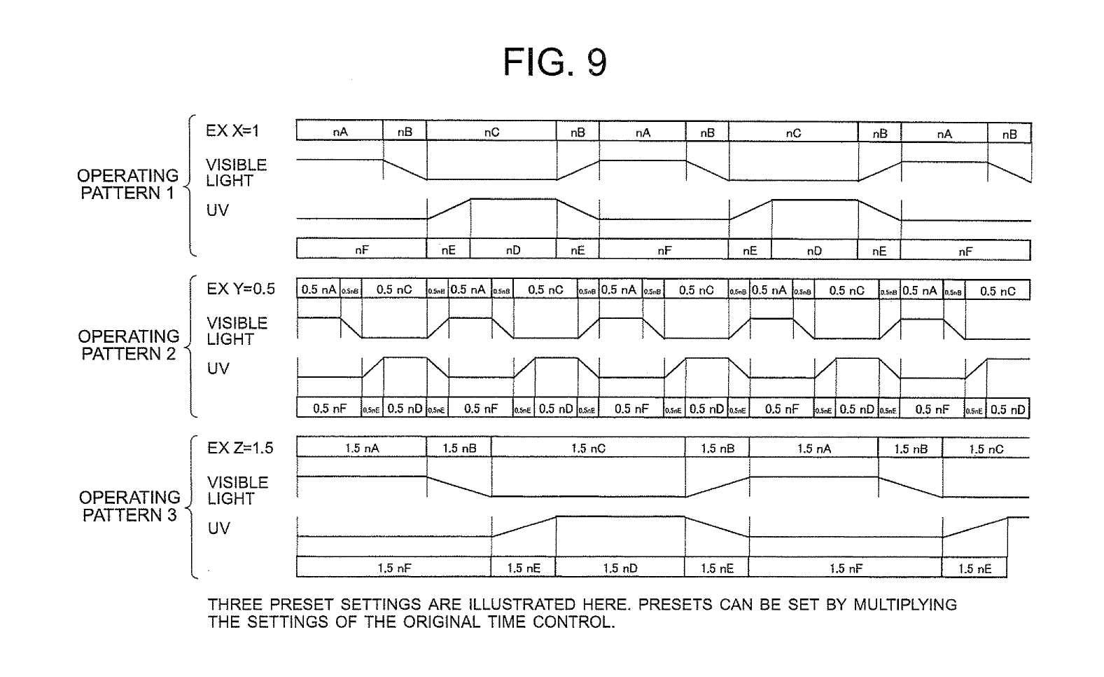

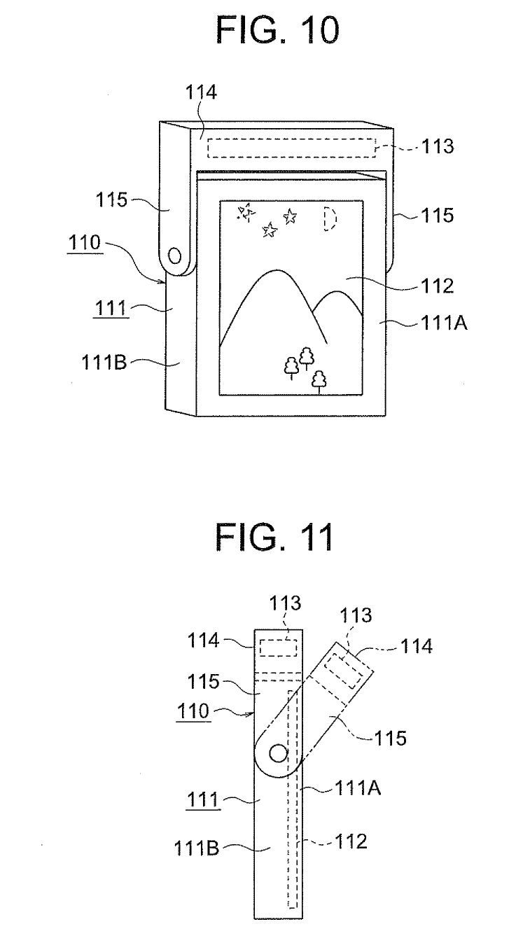

### EXPLANATION OF REFERENCES

10 display apparatus
11 box member
12d display object
12A design
12B design
14 lighting device
21 board
22A visible light emitting devices
22B ultraviolet light emitting devices
23 control unit
24 power supply
25 current adjusting unit
26 current adjusting unit
110 display apparatus
111 box member
112 display object
113 lighting device
114 light device box
115 arm part

1. A display-use lighting device comprised of:
a light device which is provided with at least one visible light emitting device and at least one ultraviolet light emitting device, and
a control means for alternately controlling a light emitting operation of said visible light emitting device and a light emitting operation of said ultraviolet light emitting device in said light device,
wherein said control means performs control to make said visible light emitting device emit light, gradually increase a light emitting intensity, then gradually decrease this light emitting intensity and extinguish the light, then make said ultraviolet light emitting device emit light, gradually increase a light emitting intensity, then gradually decrease this light emitting intensity and extinguish the light, and alternately periodically repeats said light emitting operation of said visible light emitting device and said light emitting operation of said ultraviolet light emitting device, and an additional control to separately adjust each part of a periodical wave of said light emitting emitting operation of said visible light emitting device and each part of a periodical wave of said ultraviolet light emitting device so that a pattern of change of said light emitting operation of said visible light emitting device and a pattern of change of said light emitting operation of said ultraviolet light emitting device are made different, and
visible light which said visible light emitting device emits and ultraviolet light which said ultraviolet light emitting device emits are alternately irradiated on a display object.

2. A display-use lighting device as set forth in claim 1, wherein said display object includes an image part which is sensitive to said visible light and an image part which is sensitive to said ultraviolet light.

3. (canceled)

4. (canceled)

5. A display-use lighting device as set forth in claim 1, wherein said light device is provided with a single board, and a plurality of said visible light emitting devices and a plurality of said ultraviolet light emitting devices are arranged on one surface of the board.

6. A display-use lighting device as set forth in claim 5, wherein electrical circuit elements forming said control means are provided on the other surface of said board.

7. A display-use lighting device as set forth in claim 1, wherein said display-use lighting device is provided with a supporting box member which mounts said display object, and said light device is arranged along a side-forming member of said supporting box member.

8. A display-use lighting device as set forth in claim 5, wherein said light device is set inside of said supporting box member, and said display object is alternately irradiated with said visible light from said visible light emitting devices and said ultraviolet light from said ultraviolet light emitting devices from the front surface side of said display object arranged in said supporting box member.

9. A display-use lighting device as set forth in claim 5, wherein said light device is set inside of said supporting box member, and said display object is alternately irradiated with said visible light from said visible light emitting devices and said ultraviolet light from said ultraviolet light emitting devices from the back surface side of said display object arranged in said supporting box member.

10. A display-use lighting device as set forth in claim 7, wherein said side-forming member of said supporting box member which is provided with said light device moves to a predetermined position in front of said supporting box member by being rotated around a specific axis when lighting, and said display object mounted to said supporting box member is irradiated by said light device with said visible light or said ultraviolet light in the state where said side-forming member has moved to the front, and moves to an original position by being reversed around said specific axis when not lighting.

11. A display-use lighting device as set forth in claim 1, wherein said control means is provided with a period changing means for changing each period of a periodic light emitting operation of said visible light emitting device and a periodic light emitting operation of said ultraviolet light emitting device.

12. A display apparatus comprised of:
an image display member for display use,
a light device which is provided with a visible light emitting device and an ultraviolet light emitting device, and
a control means for alternately controlling a light emitting operation of said visible light emitting device and a light emitting operation of said ultraviolet light emitting device in said light device,
wherein said control means performs control to make said visible light emitting device emit light, gradually increase a light emitting intensity, then gradually decrease this light emitting intensity and extinguish the light, then make said ultraviolet light emitting device emit light, gradually increase a light emitting intensity, then gradually decrease this light emitting intensity and extinguish the light, and alternately periodically repeats said light emitting operation of said visible light emitting device and said light emitting operation of said ultraviolet light emitting device, and an additional control to separately adjust each part of a periodical wave of said light emitting emitting operation of said visible light emitting device and each part of a periodical wave of said ultraviolet light emitting device so that a pattern of change of said light emitting operation of said visible light emitting device and a pattern of change of said light emitting operation of said ultraviolet light emitting device are made different, and
visible light which said visible light emitting device emits and ultraviolet light which said ultraviolet light emitting device emits are alternately irradiated on said image display member.

13. A display apparatus as set forth in claim 12, wherein said image display member includes an image part which is sensitive to said visible light and an image part which is sensitive to said ultraviolet light.

14. (canceled)

15. (canceled)

16. A display apparatus as set forth in claim 12, wherein said light device is provided with a single board, and a plurality of said visible light emitting devices and a plurality of said ultraviolet light emitting devices are arranged on one surface of this board.

17. A display apparatus as set forth in claim 12, wherein said display apparatus is provided with a supporting box member which mounts said image display member, and said light device is arranged along a side-forming member of said supporting box member.

18. A display apparatus as set forth in claim 17, wherein said light device is set inside of said supporting box member, and said image display member is alternately irradiated with said visible light from said visible light emitting devices and said ultraviolet light from said ultraviolet light emitting devices from the front surface side of said image display member arranged in said supporting box member.

19. A display apparatus as set forth in claim 17, wherein said light device is set inside of said supporting box member, and said image display member is alternately irradiated with said visible light from said visible light emitting devices and said ultraviolet light from said ultraviolet light emitting devices from the back surface side of said image display member arranged in said supporting box member.

20. A display apparatus as set forth in claim 17, wherein said side-forming member of said supporting box member which is provided with said light device moves to a predetermined position in front of said supporting box member, by being rotated around a specific axis when lighting, and said image display member mounted to said supporting box member is irradiated by said light device with said visible light or said ultraviolet light in the state where said side-forming member has moved to the front, and moves to an original position by being reversed around said specific axis when not lighting.
